(19) United States
(12) Patent Application Publication
(10) Pub. No.: US 2008/0129528 A1
(43) Pub. Date: Jun. 5, 2008

(54) Apparatus and method for guided tour

(76) Inventor: Michael Phipps Guthrie, New York, NY (US)

Correspondence Address: James W. Wiegand, Suite 700, 60 State Street, Boston, MA, 02109, US

(21) Appl. No.: 10/989,564

(22) Filed: Nov. 16, 2004

(51) Int. Cl. G08B 21/00

(52) U.S. Cl. 340/686.1

(57) ABSTRACT

A portable processing device includes visual and audio data related to one or more locations and provides presentations related to those locations in which the audio and visual information are presented in synchronization.

### CROSS-REFERENCE TO RELATED APPLICATIONS

None

### FIELD OF THE INVENTION

The invention relates to portable processing devices and, in particular, to the use of portable processing devices as tour guides.

### BACKGROUND OF THE INVENTION

Tourists (by which we mean visitors to a particular location, in this context) often want to learn about the places they are visiting in a relatively efficient manner. Visitors don't plan on staying for the months or years that would allow them to absorb the ambience of a town and get to know the out-of-the-way places that define the places they visit. Tour guides conduct tours to introduce tourists to landmarks, to explain the history, and to discuss the trivia and significa of a particular place. One may join a group of tourists on a predetermined route, or, at significantly greater expense, one may enjoy a more detailed and flexible tour by employing a private guide. In fact, many people know little about their own environs and they too, not just visitors, would benefit from the services of a tour guide. However, the logistics of arranging for a guided tour, the expense of employing a tour guide, and the inconvenience of fitting into a guide's schedule, and the desire to experience a place on one's own terms, not as part of a herd, reduce the appeal of guided tours.

In recent years electronically guided tours have provided an alternative to human guides. The electronically guided tours provide much greater flexibility than afforded by human guides, typically at lesser expense. Examples of electronic guided tours include those that operate in an automobile equipped with a Global Positioning System (GPS) transceiver (U.S. Pat. No. 6,266,614) and those that require interaction between a portable system and a base station during the operation of a tour (U.S. Pat. No. 6,772,213). Although such systems provide some of the independence and convenience desirable as an alternative to a human tour guide, their use is limited due to system complexity and, to some extent, lack of functionality.

An apparatus and method for providing portable electronic tour guides would be highly desirable.

### SUMMARY

In accordance with the principles of the present invention, a portable processing device provides synchronized audio and visual presentations related to predetermined locations. The portable processing device may take many forms, including that of a personal digital assistants (PDA), handheld computer, notebook computer, or display-enabled cellular telephone. The visual presentation may take the form of photographic images (with current or historical views), artistic image, computer-generated and digital images, maps (which may be interactive, topographic, or street maps), or video presentations. The audio information typically forms a narrative that describes the imagery that is presented or a point of interest in the user's immediate physical environment, but may take other forms. For example, music that may be associated with the imagery such as a recording of Jazz Coronetist Bix Beiderbecke's “Davenport Blues” may play when an image of his hometown of Davenport, Iowa is displayed, or “New York, N.Y.” may be played when a photograph of the skyline of New York City is displayed. Other sounds, such as streets sounds past or present may be played. Noted speeches associated with a landmark, for example, the fiery speeches of abolitionist Frederick Douglas may be played in association with an image of Boston's Park Street Church.

The navigational orientation for a tour system in accordance with the principles of the present invention, whereby the system presents a user with information at a related place and time, may be based, for example, on location-aware computing, using GPS, microwaves, or some other means of positioning, or on a manual system of giving the user directions, providing the user with a set of map(s) and visual references and relying on the user to follow the tour's route accurately. A manual system may also allow a user to, for example, interact with the maps, visual references or other locating features to update his position or to alter the sequence of locations to be visited along a tour route.

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a conceptual block diagram of a portable processing system such as may be employed by a system and method in accordance with the principles of the present invention;

FIG. 2 is a functional block diagram of a system in accordance with the principles of the present invention;

FIG. 3 is a flowchart that provides an overview an electronic guided tour in accordance with the principles of the present invention;

FIGS. 4 through 12 are screen shots that display the functionality of an electronic guided tour in accordance with the principles of the present invention; and

FIG. 13 is an XML listing that details the synchronization of image and audio information in accordance with the principles of the present invention.

### DETAILED DESCRIPTION

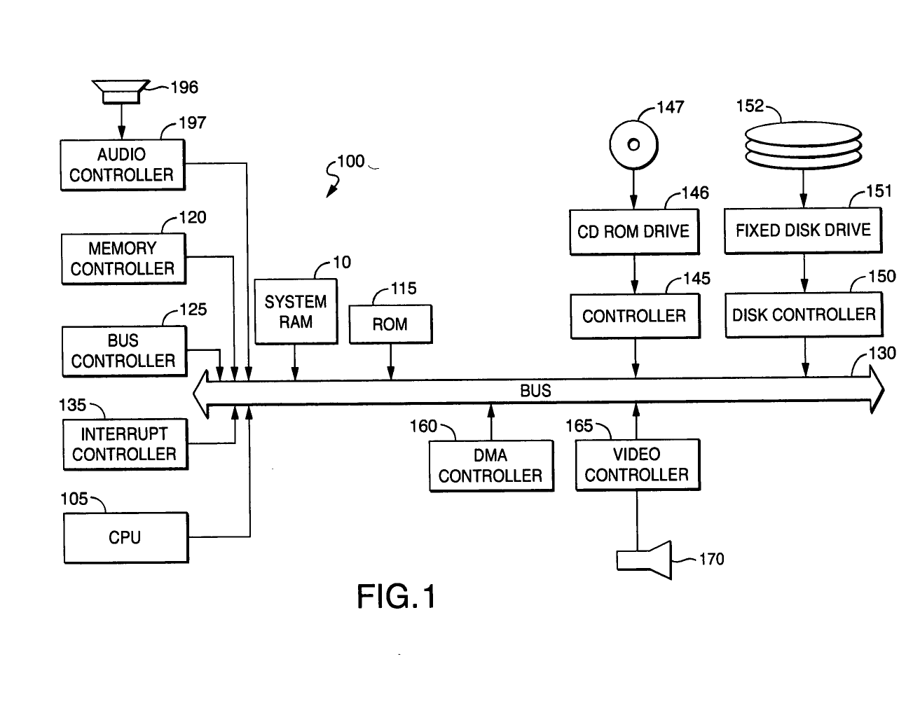

FIG. 1 illustrates the system architecture for a portable processor 100 on which the invention may be implemented. The exemplary computer system of FIG. 1 is for descriptive purposes only. Although the description may refer to terms commonly used in describing particular computer systems, the description and concepts equally apply to other systems, including systems having architectures dissimilar to FIG. 1.

Portable processor 100 includes a central processing unit (CPU) 105, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of portable processor 100. A bus controller 125 is provided for controlling bus 130. An interrupt controller 135 is used for receiving and processing various interrupt signals from the system components.

Mass storage may be provided by CD ROM 147 or hard drive 152. Data and software may be exchanged with portable via removable media such as flash memory or CD ROM 147. Similarly, CD ROM 147 is insertable into CD ROM drive 146 (which may be external) which is, in turn, connected to bus 130 by controller 145. Hard disc 152 is part of a fixed disc drive 151 which is connected to bus 130 by controller 150.

User input to portable processor 100 may be provided by a number of devices. For example, touch sensitive display 170 is connected to bus 130 by controller 165 that may include a graphical user interface. An audio transducer 196, which may act as both a microphone and a speaker, is connected to bus 130 by audio controller 197, as illustrated. It will be obvious to those reasonably skilled in the art that other input devices, such as a pen and/or tabloid may be connected to bus 130 and an appropriate controller and software, as required. DMA controller 160 is provided for performing direct memory access to RAM 110. Portable processor 100 also includes a communications adaptor 190 which allows the system to be interconnected to a network or a cellular telephone network, for example.

Operation of portable processor 100 is generally controlled and coordinated by operating system software. The operating system controls allocation of system resources and performs tasks such as processing scheduling, memory management, networking, and I/O services, among things. In particular, an operating system resident in system memory and running on CPU 105 coordinates the operation of the other elements of portable processor 100. The present invention may be implemented with any number of operating systems, including commercially available operating systems. One or more applications, such may also run on the CPU 105. If the operating system is a true multitasking operating system, multiple applications may execute simultaneously.

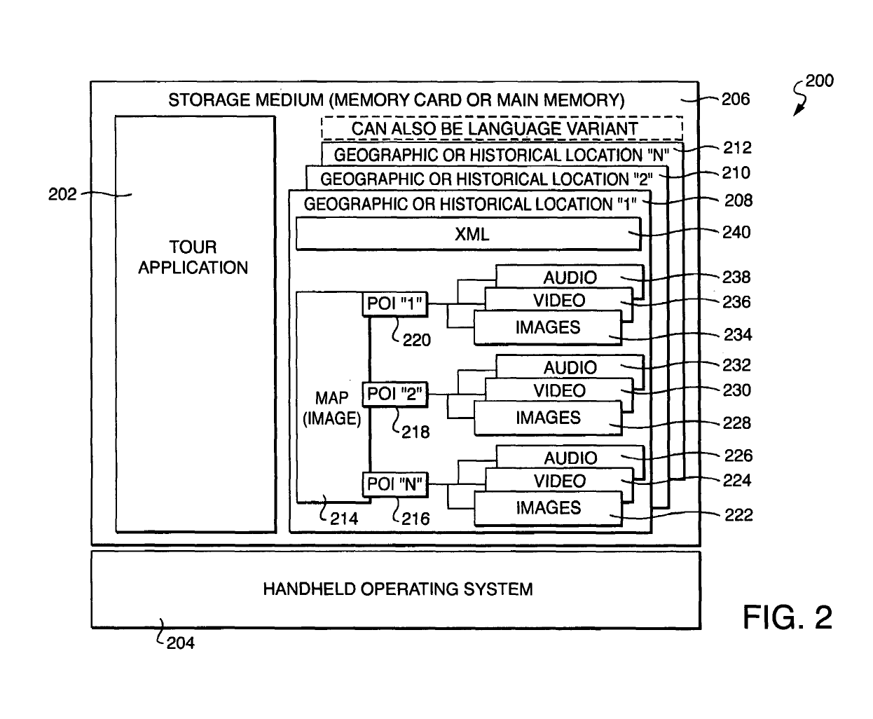

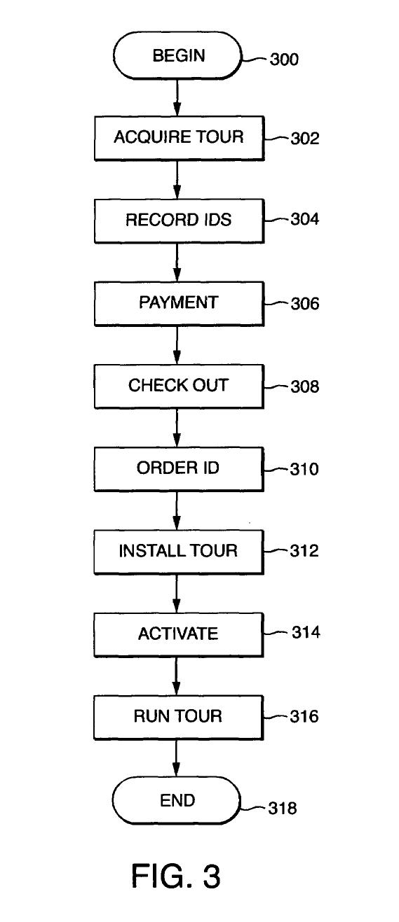

The functional block diagram of FIG. 2 illustrates the general organization of various software components 200 of a portable tour system in accordance with the principles of the present invention. A tour application 202, the various functions of which will be described in greater detail in the discussion related to subsequent figures, interfaces with an operating system 204. As is known to those familiar with the art, a great deal of the software functionality may be offloaded to the operating system 204, which may provide a variety of common functions, including basic functions related to a user interface, including user input, sound production, and basic display addressing, via calls from the tour application 202 to the operating system 204. The operating system 204 may be a standard operating system provided by the processor upon which the guided tour in accordance with the principles of the present invention operates or it may be a proprietary operating system that is bundled with the guided tour. The application 202 has access to various forms of data that is arranged in files, such as location file 1 208, location file 2 210, and location file 3 212. In accordance with the principles of the present invention, each file may be related to a specific geographical location as well as related historical or language variants related to the location. In an illustrative “streaming” embodiment, the tours would not be stored locally on the portable processing device, rather, they would be delivered from a central storage device, such as an on-line server. Whether the tour were stored locally on the portable processor or delivered to the portable processor via a streaming application, the organization of the various files, with location files and associated image and audio files may be implemented as illustrated in the conceptual block diagram of FIG. 3. Storage devices that may be employed by the portable processor include, but are not limited to local and portable flash memory, read only memory cards, hard drives, CD ROM, and streamed content delivered from a central database via the Internet, for example.

The navigational orientation for a tour system in accordance with the principles of the present invention, whereby the system presents a user with information at a related place and time, may be based, for example, on location-aware computing, using GPS, microwaves, or some other means of positioning, or on a manual system of giving the user directions, providing the user with a set of map(s) and visual references and relying on the user to follow the tour's route accurately. A manual system may also allow a user to, for example, interact with the maps, visual references or other locating features to update his position or to alter the sequence of locations to be visited along a tour route.

For the sake of brevity and clarity of explanation I will describe the contents of one location file, more specifically, of location file 1 208. All other location files may have similar contents. Each location file may be associated with one or more separate “tours” provided in accordance with the principles of the present invention and each tour may be associated with one or more location files. Location file 1 208 includes a map file 214. Points of interest 216, 218, and 220 are associated with the map file 214. Each point of interest 216, 218, 220, may operate as a “tag”, a pointer, or other mechanism known to those in the art, keyed to a particular location (which could be a geographical location) within the area defined by the map file 214, and which points to audio, graphic, or video information. If, for example, the map file 214 is associated with a tour of New York City, the point of interest 216 may be keyed to Grant's tomb and the image 222, video 224 and audio 226 files pointed to by the tag 216 may respectively include a photograph, a painting, or other image of Ulysses S Grant, a video depicting, for example, his home town of Galena Ill., and one or more audio files that are coordinated with the image and video files and which, for example, describe his humble origins in Galena and his rise to the presidency. Similarly, point of interest tag 218 may be associated with the reservoir within central park and may point to image 228, video 230, and audio 232 files that include the various forms of information previously described, but, in this instance, related to the reservoir. Point of interest 220 may refer to another geographical location within Central Park or a historical location related to the park, such as a structure or landscaping feature developed by the park's designer Frederick Law Olmstead, and associated image 234, video 236, and audio files 238 perform functions similar to those just described.

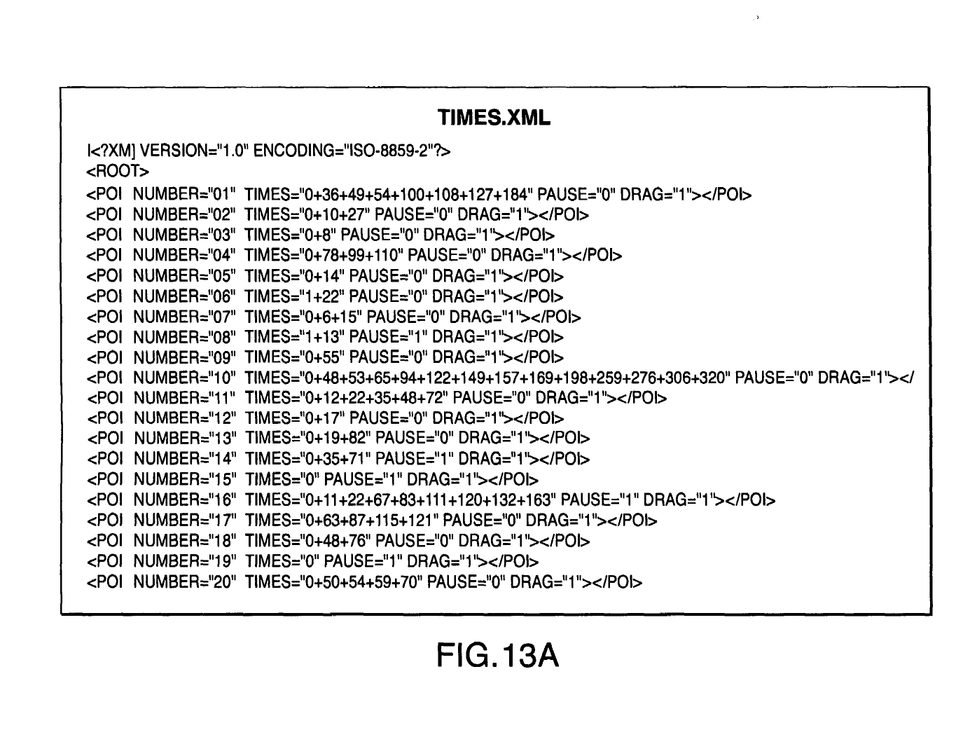

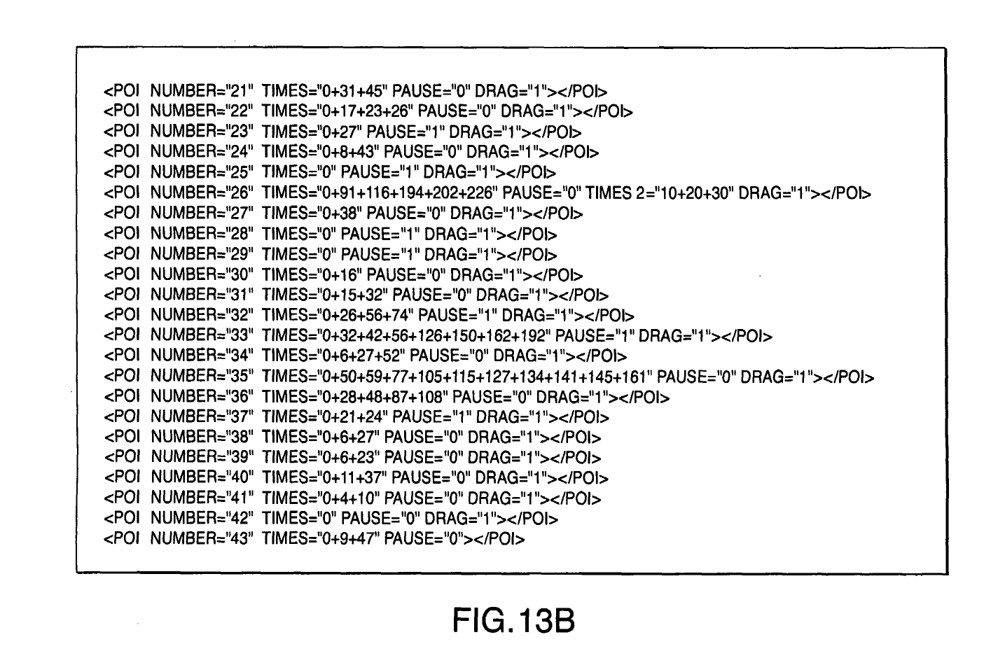

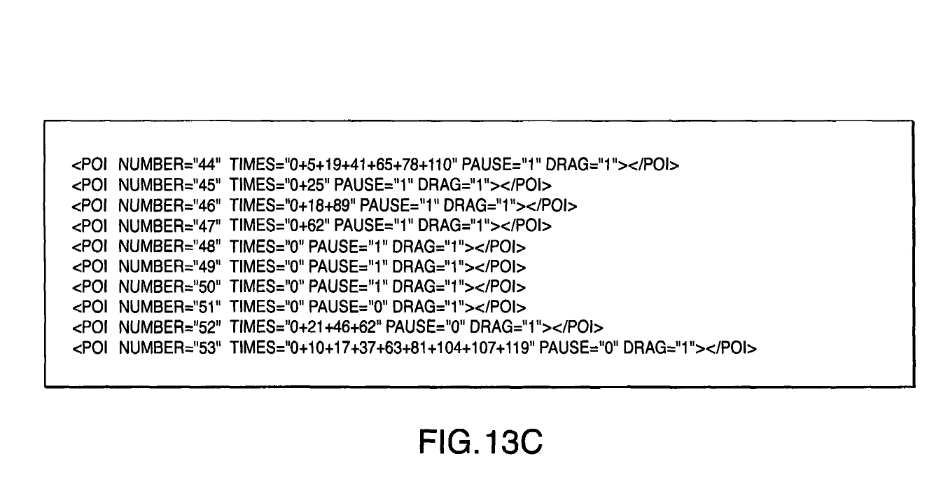

The tour application file 202 operates in conjunction with the XML file 240, as will be described in greater detail in the discussion related to FIG. 13, to synchronize the presentation of image, video, and audio information to a user. Each location (whether geographical, historical, or other type) may have any number of maps associated with it and each map may have any number of points of interest associated with it. As one familiar with the art will recognize, the application 202, operating system 204 and various data structures (e.g., image 214, audio file 226, etc.) may be stored in a memory device 206, which may take the form of a memory card, an optical or magnetic disk, or a flash memory device, for example.

The process of acquiring and initiating a tour in accordance with the principles of the present invention will now be described in conjunction with the discussion of the flow chart of FIG. 3. Although the discussion is directed to the use of a personal digital assistant for the tour, portable electronic processors of many varieties, including hand-held computers, laptop computers, and cellular telephones may be employed as a guided tour processor in accordance with the principles of the present invention. The process begins in step 300 and proceeds to step 302 where a user acquires a tour product in accordance with the principles of the present invention. The user may acquire a tour product through a variety of means. For example, a user may download the tour application, and tour location, point of interest, audio, image, and video files (the sum of which may be referred to herein as “the tour”) from the Internet or acquire a portable delivery system, such as a CD ROM, local and portable flash memory, read only memory cards, hard drives, streamed content delivered from a central database via the Internet, for example that contains the tour. Whichever means an end-user employs to obtain the tour, one or more tours, each with one or more locations, maps, points of interest, etc. may be included. If the tour is acquired from a CD ROM, a user is instructed to insert the CD ROM into, for example, a personal computer that is capable of connecting to the Internet. Alternatively, the user may employ a portable processor that is capable of connecting to the Internet and includes an internal or external CD ROM drive. The user is instructed to enter a product identification from the package, and to select one or more tours from a list presented on to him. From step 302 the process proceeds to step 304 where the computer (or portable processor) records the product identification and the identification of the one or more tours selected by the user. Alternatively, a user may interact with an call center operator (human or otherwise) that provides the user with product and tour identifications.

From step 304 the process proceeds to step 306 where the user interacts with a server to arrange for payment and activation of the selected tours. If the user has downloaded the tour from the Internet in step 302, he may already be online and connected to the tour vendor's server. If he obtained the tour from a portable delivery system, he may connect to the Internet and the vendor's server at this point. Various charges are applied for the user's selected tours, based, for example on the tour identifications. Discounts may also be applied, based, for example, on the product identification entered by the user in step 302. A familiar “shopping cart” metaphor may be employed by the server in order to charge the user and finalize his order. In response to prompts from the tour vendor's server, the user enters his name, credit card information, shipping and billing addresses, email address and password (which may have previously been emailed to the user during a registration process).

From step 306, the process proceeds to step 308 where the check-out process is finalized. The user's credit card issuer authorizes (or rejects) payment in a known manner. Once payment is authorized, the tour operator's server generates an order identification and a customer identification. The process then proceeds to step 310 where the vendor's server sends the order identification to the user. The order identification may be immediately presented to the user on-screen or, for a more secure transaction, the order identification may be emailed to the user's email address. Additionally, the specifics of the order (that is, the tour identifications, the order identification and customer identification) are copied to an activation database resident on the user's computer (or portable processor). From step 310 the process proceeds to step 312 where, if the user has been using a computer other than the portable processor upon which he plans to use the tours, the user installs the tours on his portable processor, along with the activation database. Upon installation of a tour, tour software in accordance with the principles of the present invention runs an application that creates a device identifier that is unique to the portable processor upon which the tour is going to operate. The device identifier may be based upon the portable processor's central processing unit serial number, for example. The tour software employs the unique device identifier to ensure that only the portable processor associated with the purchase of the tour can run the tour. The device identifier is stored in a data file and, as described in greater detail in the discussion related to step 312, compared to, effectively, a run-time copy of the device identifier in order to limit operation of the tour to the portable processor for which the tour has been purchased.

From step 312, the process proceeds to step 314 where the user initiates activation of the tour on his portable processor. In this illustrative embodiment, the portable processor's hardware serial number, that is the central processing unit's serial number, is used to form the device identifier. The device identifier is encrypted and stored in an activation database, along with information regarding the tour or tours being activated. When the activation process is initiated, the portable processor sends the identifier to the main database of the server processing the order. Once payment is accepted, the server returns the identifier to the portable processor, which stores the returned identifier in a location separate from the initially stored version of the identifier. When a tour is launched within the portable processor, the tour code compares the first-stored identifier to the identifier returned by the server. If the identifiers match, the tour is enabled. Various operations, such as encryptions, may be performed at various points during the activation process. For example, the identifier may be encrypted before being sent to the server and may be encrypted before being returned from the server to the portable processor, for example. The exchange and comparison of identifiers ensures that only the portable processor for which the tour was purchased may run a tour.

From step 314 the process proceeds to step 316, where a tour is selected and run. The selection and operation of a tour will be described in greater detail in the discussion related to the following screen shots. At the completion of a tour, the process proceeds to end in step 318.

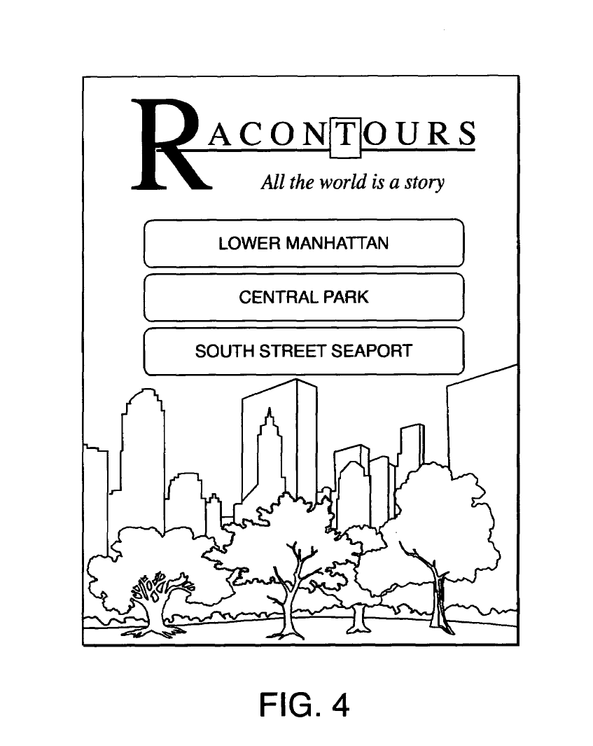

The screen shot of FIG. 4 illustrates an opening screen presented to a user of a guided tour in accordance with the principles of the present invention. In this illustrative embodiment, three separate tours of Manhattan are offered, represented by selection boxes labeled Lower Manhattan, Central Park, and South Street Station. In an illustrative handheld portable processor embodiment, a user views the application in full screen mode, with Flash Player bar and menu bar eliminated. A user may select one of the tours, through use of a stylus, keypad or keyboard, for example. In other embodiments, a Macromedia Flash Player bar and menu bar are included at the top of the display.

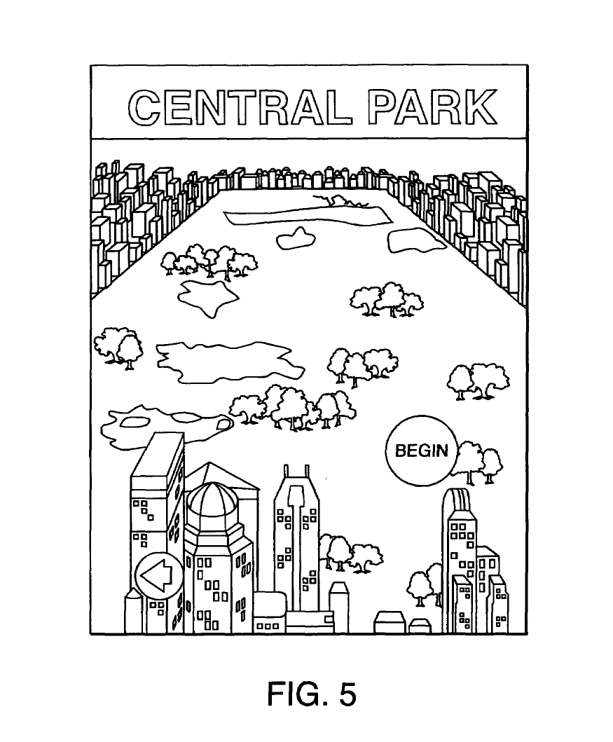

For purposes of illustration we will assume that a user has selected the “Central Park Tour”, in which case the display would shift to the screen shot of FIG. 5. A graphic, in this case and aerial photo of Central Park, introduces the user to the selected tour. An interactive button, labeled “Begin” in FIG. 5, allows a user to start the selected tour by activating the “begin” button, with a stylus for example.

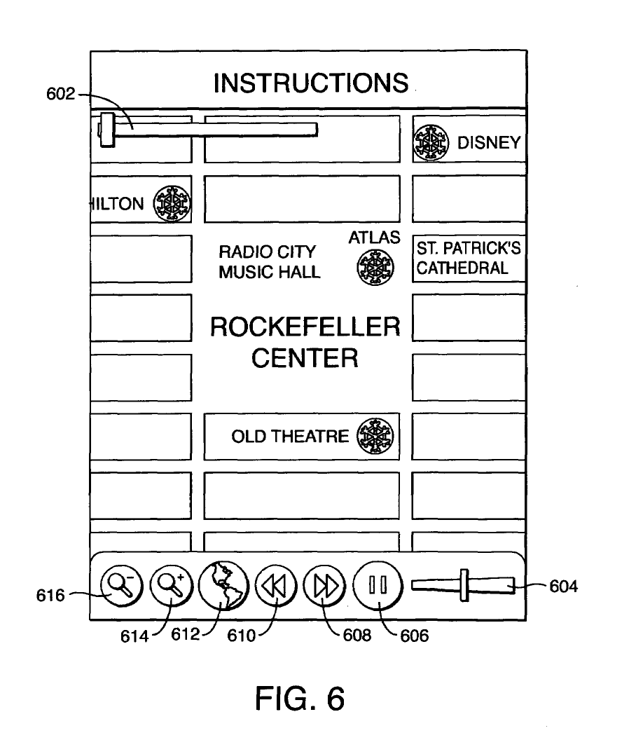

Once activated, the tour proceeds to an instruction page, as illustrated in the screen shot of FIG. 6. In accordance with the principles of the present invention, the instructions presented by the tour guide simulate an actual tour. In this illustrative example, the display presents a map that includes a variety of points of interest which a user may select. In addition to points of interest, such as landmarks, historical, and architectural sites, a tour may include commercial points of interest. For example, in this illustrative example, in addition to the architectural point of interest, Rockerfeller Center and the cultural point of interest Radio City Music Hall, the commercial points of interest include a Hilton Hotel, a Disney Store and The Old Theatre. Commercial points of interest may be included in response to the payment of fees to the tour vendor by the operators of the establishments represented by the commercial point of interest icons on the tour map.

The map is an interactive map that permits a user to zoom, drag and to click on items of interest. When an item is selected by the user's clicking, if item is an interactive item, the system will provide a information to the user, via an audio presentation and/or a graphical presentation (which could include still graphics, such as computer generated images, or photographs, or video images). The progress bar 602 provides a user with an analog representation of the amount of time spent and remaining with the presentation and, in an illustrative embodiment, allows a user to “fast forward” or “reverse” in the presentation by dragging the bar in a forward or reverse direction, respectively. Buttons in the operation bar at the bottom of the screen allow a user to control the volume of the presentation 604, to pause the operation of the tour 606, to go forward in the presentation 608, to return to an earlier part of the presentation 610, to toggle between images, such as map and point of interest images 612, to zoom in 614, and to zoom out 616. The fast-forward 608 and rewind 610 buttons allow a user to skip between tracks in a tour. The tour employs the instruction screen of FIG. 6 to “walk a user through” the operation of the tour guide system. Once the instruction is completed, the main tour file is automatically launched. In this illustrative embodiment, the main tour file shares all of the instructions file's aforementioned features as well as others described below, thereby affording a user a uniform system interface

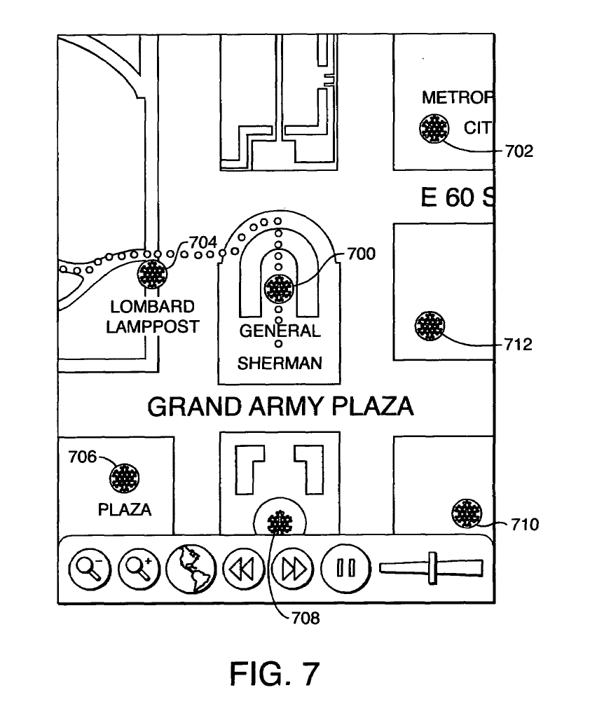

The screen shot of FIG. 7 illustrates some of the features of a portable processor guided tour in accordance with the principles of the present invention. The Macromedia Flash bar, Menu bar, and operation bar are as previously described. Points of interest are indicated by icons, and “active points of interest”, that is, the currently selected point of interest, are indicated by “highlighting” the selected icon. As is known in the art, the highlighting may take many forms, such as changing the color of the icon, flashing the icon, or encircling the icon, for example. In this illustrative embodiment, the General Sherman icon 700 is the active point of interest, and other points of interest, including The Metropolitan Club 702, Lombard Lamppost 704, The Plaza 706, The Pulitzer Fountain 708, and The General Motors Building 710 are inactive. The main tour file is launched in a pause mode, which requires the user start the actual tour. A user may enter the pause mode at any time, in order, for example, to reflect upon the tour's narrative or to examine more closely an item that is described in the tour's narrative. Each point of interest file and audio file, an mp3 file in this illustrative embodiment, are loaded and linked to corresponding point of interest icons.

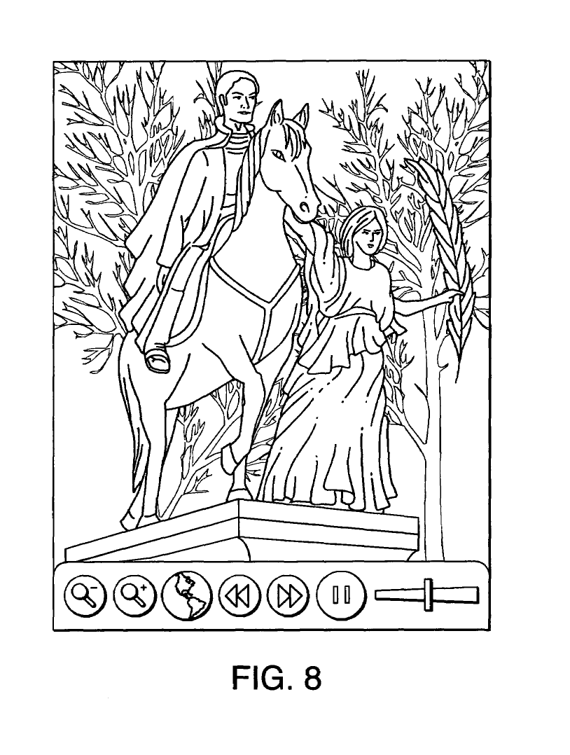

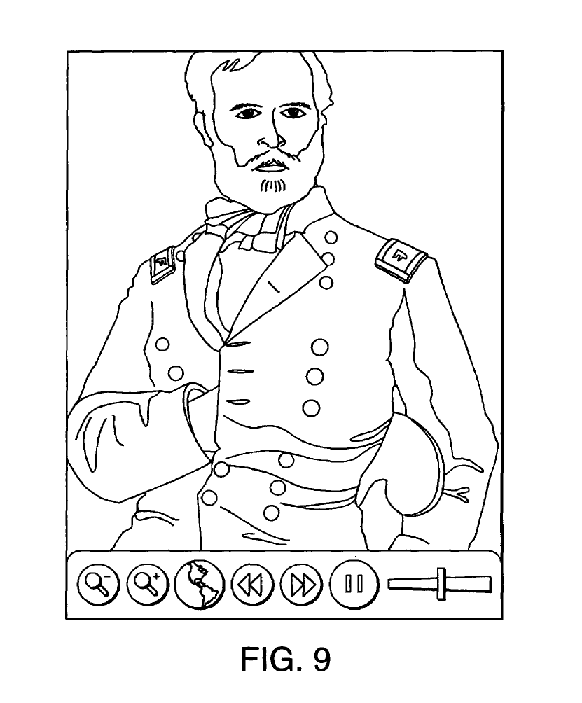

Once an icon has been selected, as, in this example, the General Sherman icon has been selected, and the user has exited the pause mode, by, for example, touching the pause button in the control bar with a stylus, or employing the keypad of a cellular telephone, the tour proceeds from the map of FIG. 7 to the photographic screenshot of FIG. 8. In this illustrative embodiment, the photograph of the statue of General Sherman provides a reference for the user. A progress bar (at the top left of the image in this illustrative embodiment) indicates to a user the progress of the tour narrative and allows a user to fast forward or rewind within the narrative associated with the currently active icon. The image is embedded within an image file and, in this illustrative embodiment, each point of interest has an associated image file and associated, audio (e.g., mp3) file. The screen shot of FIG. 9 is embedded in the same image file as that of FIG. 8 and is associated with the next part of the narrative audio related to the currently active point of interest.

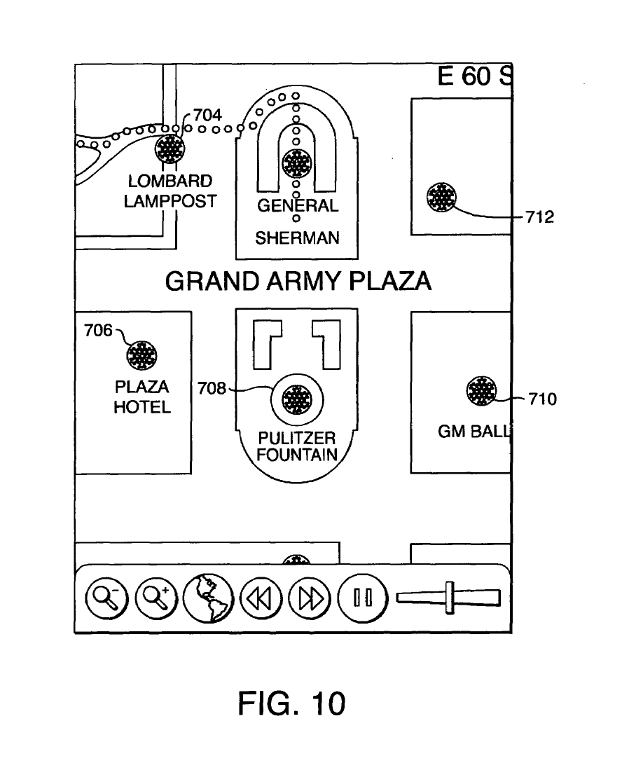

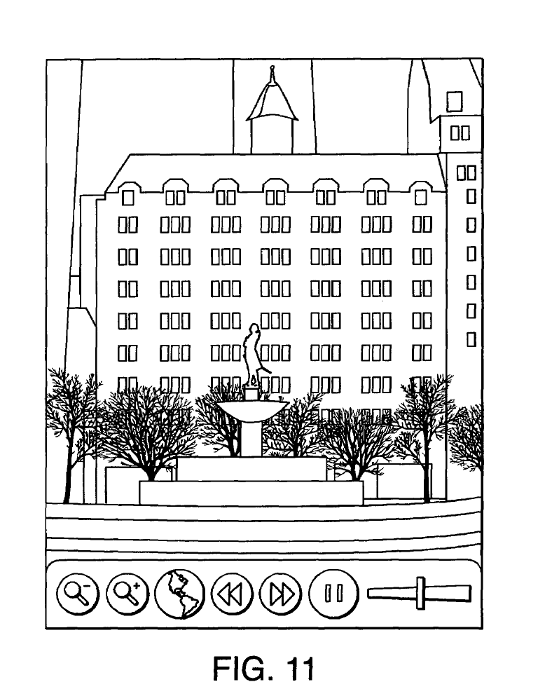

The screen shot of FIG. 10 provides a view of the main tour map as the tour proceeds to another point of interest. In accordance with the principles of the present invention, the tour provides a default sequence of points of interest, but a user may intervene with that sequence in order to skip specific points of interest or to view them in a different sequence from the pre-programmed sequence. In this illustrative embodiment, the active point of interest has changed. As previously noted, the user may toggle between a map view, as exemplified in FIG. 10, and point of interest images, as exemplified by the image in the screen shot of FIG. 11. The button 612 may be highlighted to provide a user with an additional indication regarding the type of view, that is, map view or point of interest image view, currently being presented. The active point of interest is, as previously described, highlighted and this highlighting provides the user with an indication of where he should direct his attention, particularly if the tour is proceeding in a pre-scripted fashion, and the user hasn't chosen the next point of interest.

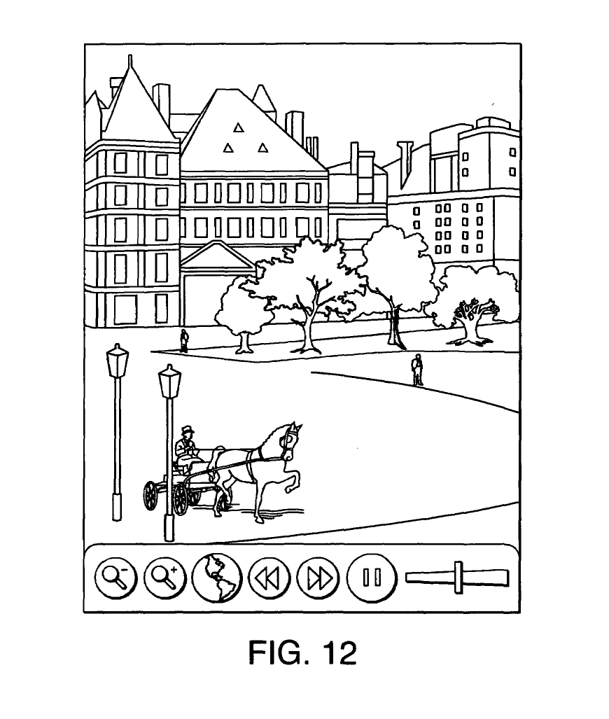

The screen shot of FIG. 11 is a current photographic image of the active point of interest at 59^{th} street and 5^{th} avenue. In this illustrative embodiment, a historical image of 59^{th} street and 5^{th} avenue is available, as indicated by the screen shot of FIG. 12. A tour proceeds from point of interest to point of interest until all the points of interest in a particular tour have been reached or until the user selects “tour end”, which, in an illustrative embodiment, is available at each screen. At the end of a tour, the application resets to the introductory page.

In accordance with the principles of the present invention, one or more sets of image information related to one or more locations are presented with synchronized audio information. In an illustrative embodiment, this image/audio synchronization is accomplished in though use of an XML file as described in the discussion related to FIG. 13. In an illustrative embodiment, an XML file, such as that of the file listing of FIG. 13 controls the synchronization between the tour's audio and image presentation. The main tour file reads the times for each point of interest and calls up images from the associated swf file at the times specified in the XML listing. For example with point of interest number one, a first associated image is presented to the user at the start of point of interest number one's executions, that is at “0” seconds. A second image is presented at 36 seconds, a third is presented at 49 seconds, and so on. The pause parameter controls whether the next sequential point of interest is launched in pause or play mode, thereby allowing a user time between points of interest, in order to walk between points of interest, for example. The drag function controls whether the image on the screen can be dragged with a stylus to, for example, “move the screen around” to display different portions of a map.

The foregoing description of specific embodiments of the invention has been presented for the purposes of illustration and description. It is not intended to be exhaustive or to limit the invention to the precise forms disclosed, and many modifications and variations are possible in light of the above teachings. The embodiments were chosen and described to best explain the principles of the invention and its practical application, and to thereby enable others skilled in the art to best utilize the invention. It is intended that the scope of the invention be limited only by the claims appended hereto.

What is claimed is:

1. A portable electronic apparatus, comprising:
data storage including visual and correlated audio information related to at least one geographical location;
a processor; and
a graphical user interface, wherein the processor is configured to present the audio and correlated visual information in synchronization.

2. The apparatus of claim 1 further comprising:
audio components; and
display components, the processor configured to display, in response to user interaction, visual information related to one or more locations, along with related audio information.

3. The apparatus of claim 1 wherein the visual information includes photographic images.

4. The apparatus of claim 3 wherein the visual information includes historical and current photographic images of the same location.

5. The apparatus of claim 1 wherein the visual information includes a map that includes a representation of at least one location having visual and correlated audio information stored within the database.

6. The apparatus of claim 5 wherein the map is an interactive map.

7. The apparatus of claim 1 wherein the visual information includes video information.

8. A portable electronic apparatus, comprising:
data storage including visual and correlated audio information related to at least one geographic location;
a processor; and
a user interface including audio and display components, the processor configured to display, in response to user interaction, visual information related to one or more locations, along with related audio information and to direct a user along a predetermined route among a plurality of locations.

9. The apparatus of claim 8 wherein the visual information includes photographic images.

10. The apparatus of claim 9 wherein the visual information includes historical and current photographic images of the same location.

11. The apparatus of claim 8 wherein the visual information includes a map that includes a representation of at least one location having visual and correlated audio information stored within the database.

12. The apparatus of claim 11 wherein the map is an interactive map.

13. The apparatus of claim 8 wherein the visual information includes video information.

14. The apparatus of claim 8 wherein the audio information includes narrative information related to the at least one geographic location.

15. The apparatus of claim 8 wherein the audio information includes music.

16. The apparatus of claim 8 wherein the processor is further configured to obtain and current location information to a user.

17. A method for use in a portable electronic apparatus that includes a processor, an audio system and a display, comprising the steps of:
loading data storage including visual and correlated audio information related to at least one geographic location into the portable electronic apparatus; and
responding to user input to the portable electronic apparatus by displaying visual information related to at least one geographic location, and by producing audio information correlated with the displayed visual information.

18. The method of claim 17 wherein the step of responding to user input further comprises the step of interacting with a user through a graphical user interface.

19. The method of claim 17 wherein the step of displaying visual information includes displaying photographic images.

20. The method of claim 19 wherein the step of displaying visual information includes displaying historical and current photographic images of the same location.

21. The method of claim 17 wherein the step of displaying visual information includes displaying a map that includes a representation of at least one location having visual and correlated audio information stored within the database.
